(19) United States
(12) Patent Application Publication
(10) Pub. No.: US 2005/0277413 A1
(43) Pub. Date: Dec. 15, 2005

(54) Method of chasing position of mobile communication terminal using global positioning system

(76) Inventor: Young Sung Kim, Seoul (KR)

Correspondence Address: DICKSTEIN SHAPIRO MORIN & OSHINSKY LLP, 2101 L Street, NW, Washington, DC, 20037, US

(21) Appl. No.: 11/066,231

(22) Filed: Feb. 25, 2005

(30) Foreign Application Priority Data
Jun. 11, 2004 (KR) 10-2004-0043021

(51) Int. Cl. H04Q 7/20

(52) U.S. Cl. 455/435.1; 455/456.1; 455/428

(57) ABSTRACT

Disclosed is a method of chasing position of a mobile communication terminal using GPS capable of transmitting/receiving the information required for chasing position between the mobile communication terminal and a mobile communication system without changing into Traffic mode. According to the invention, the mobile communication terminal receives the GPS satellite information from the mobile communication system via a paging channel, and transmits Pseudo Range Measurement (PRM) and Pilot Phase Measurement (PPM) information to the mobile communication system via an access channel. Accordingly, it is possible to solve the problems of a power consumption of the mobile communication terminal due to the Traffic mode, an error of the position information due to an occurrence of a hand-off during the Traffic mode and overloads due to a concentration of a plurality of Traffic channels into a specific base station.

### CROSS-REFERENCE TO RELATED APPLICATION

The present application is claiming priority of Korean Patent Application No. 10-2004-0043021, filed on Jun. 11, 2004, the content of which is herein incorporated by reference.

### BACKGROUND OF THE INVENTION

1. Field of the Invention

The present invention relates to a method of chasing position of a mobile communication terminal using a Global Positioning System (GPS), and more particularly, to a method of chasing position of a mobile communication terminal capable of transmitting/receiving the information required for chasing position between the mobile communication terminal and a mobile communication system without changing into Traffic mode.

2. Description of the Related Art

Technologies of chasing position of diverse objects have being developed. Among them, it has been used widely to several methods of chasing position of a mobile communication terminal using a GPS.

There are several methods for chasing position of a mobile communication terminal like as follows:

One is a handset-based position chasing method that uses modem (mobile station modem) capable of receiving a GPS signal in a mobile communication terminal and measures transmittance time of GPS signal from GPS satellite to a mobile communication terminal.

Another is a network-based position chasing method that measures transmittance time of a signal that is generated from a base station and transmitted to a mobile communication terminal.

And there is a hybrid method using the above two methods.

In any case, a mode of the mobile communication terminal should be firstly changed into Traffic mode in order to chase position of a mobile communication terminal using the GPS. Because information required for chasing position should be exchanged between the mobile communication terminal and a mobile communication system via a Traffic channel formed on the Traffic mode.

A method of chasing position of a mobile communication terminal using the GPS according to the prior art is as follows.

If there is a request of chasing position of a mobile communication terminal, a mobile communication system to which a user of the mobile communication terminal has subscribed as subscriber transmits GPS satellite information to the mobile communication terminal. The mobile communication terminal receiving the information from the mobile communication system can perform searching of GPS satellite.

The information receiving from the mobile communication system comprises Acquisition Assistance (AA), i.e., information about an altitude of the GPS satellite, a value of Doppler, and an azimuth, etc.

Meanwhile, the mobile communication system requests Pseudo Range Measurement (PRM) and Pilot Phase Measurement (PPM) information required for position measurement to the mobile communication terminal together with the transmitting of the AA information.

The mobile communication terminal searches a GPS satellite that recognizes the terminal, based on the AA information, and then transmits information about the search result to the mobile communication system. At this time, the information transmitted to the mobile communication system comprises the PRM and PPM information.

The mobile communication system calculates a precise position of the mobile communication terminal through Position Determination Entity (PDE), based on the PPM and PRM information. The information of the position calculated by the PDE is transmitted to requester through a series of process.

In the position chasing process as described above, according to the prior art, a mode of mobile communication terminal should be always changed into Traffic mode so that the information required for chasing position can be transmitted/received between the mobile communication system and the mobile communication terminal.

In other words, the prior art is structured such that the mobile communication terminal is firstly changed into the Traffic mode and assigned the Traffic channel from the base station of the mobile communication system and transmits/receives the GPS information used for the chasing position via the Traffic channel. However, the change into the Traffic mode for the chasing position may cause several problems.

For example, if Hand-off phenomenon has occurred in the mobile communication terminal during the receiving time of the GPS satellite information from the mobile communication system at Traffic mode, a call connection is interrupted, so that units receiving the position information may not properly operate or there may occur an error of the position information.

In addition, if many of mobile communication terminals are changed into the Traffic state in a service area of a specific base station simultaneously, the base station should assign Traffic channels to all of mobile communication terminals. Accordingly, a channel capacity of the base station is exceeded and thus many loads may be caused.

Meanwhile, if a mode of the mobile communication terminal is changed into the Traffic mode for chasing position, an electric current in the mobile communication terminal is consumed 100 times as much as a standby state at least, so that a battery of the mobile communication is exhausted in a short time.

### SUMMARY OF THE INVENTION

Accordingly, the present invention has been made to solve the above-mentioned problems occurring in the prior art. The object of the present invention is to provide a method of chasing position of a mobile communication terminal capable of transmitting/receiving information required for position phase between the mobile communication terminal and a mobile communication system without changing into Traffic mode.

In order to accomplish the objects, there is provided a method of chasing position of a mobile communication terminal using a GPS comprising steps of registering inherent information of the mobile communication terminal with a mobile communication system; transmitting a GPS satellite information comprising AA and requesting position information required for chasing position via a paging channel from the mobile communication system to the mobile communication terminal; searching a GPS signal in the mobile communication terminal; transmitting the position information obtained from the searching result via an access channel from the mobile communication terminal to the mobile communication system; and calculating position of the mobile communication terminal, based on the position information transmitted via the access channel.

According to the invention, the inherent information comprises an Electronic Serial Number (ESN) and a Mobile Identification Number (MIN).

According to a preferred embodiment of the invention, the paging channel may be opened during an idle state in a slot mode of the mobile communication terminal.

In addition, according to the invention, the slot mode may further comprise an extra slot. Like this, when the extra slot is added, the idle state of the slot mode may be extended as much as the extra slot, and a sleep state of the slot mode may be reduced as much as the extended idle state so that a total period of the slot mode is constant.

According to an embodiment of the invention, the transmittance of the position information via the access channel may be performed every preset access period.

According to the invention, the information required for chasing position may comprise PPM and PRM information.

### BRIEF DESCRIPTION OF THE DRAWINGS

The above and other objects, features and advantages of the present invention will be more apparent from the following detailed description taken in conjunction with the accompanying drawings, in which:

FIG. 1 shows a sequence of chasing position of a mobile communication terminal according to an embodiment of the invention;

FIG. 2 shows a waveform of a slot of the mobile communication terminal; and

FIG. 3 is a waveform of a slot that further comprises extra slot compared to the slot in FIG. 2.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

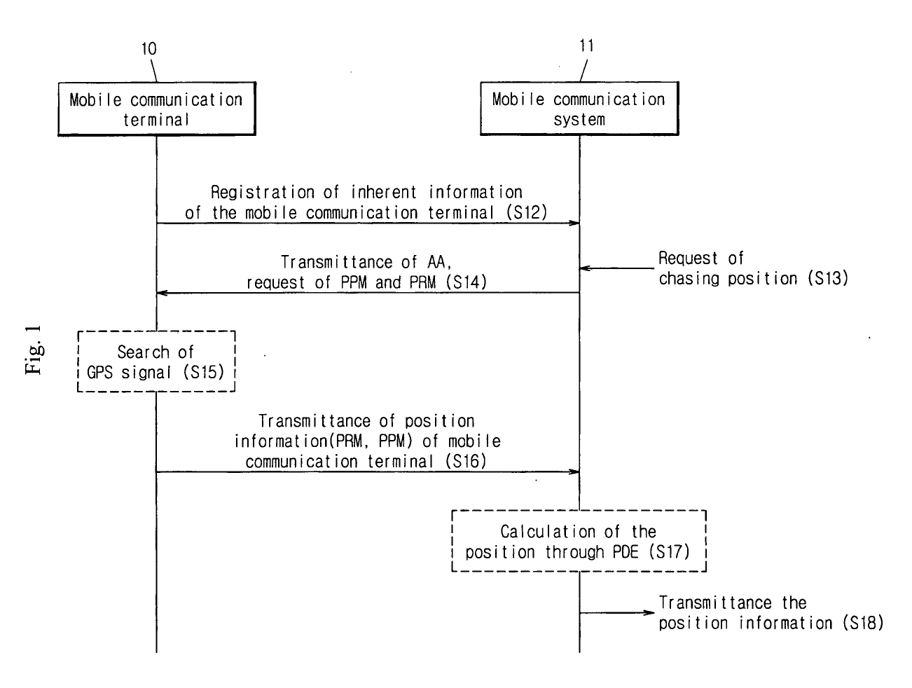

FIG. 1 shows a sequence of chasing position of a mobile communication terminal according to an embodiment of the invention. According to the invention, inherent information of a mobile communication terminal 10 is registered with a mobile communication system 11 via an access channel at any time. The information can be registered regularly in the mobile communication system 11 every predetermined time (for example, 10 minutes, 20 minutes or 30 minutes), that is, access period (S12).

In this case, the inherent information registered in the mobile communication system 11 comprises, for example, an Electronic Serial Number (ESN) which is an inherent number assigned to a mobile communication terminal so as to distinguish from other mobile communication terminals, a Mobile Identification Number (MIN) meaning a telephone number of a mobile communication terminal, a Reference PN, channel information, a System IDentification (SID), a Network IDentification (NID), a Band Class, and Pilot Phase Measurement (PPM) such as pilot intensity, etc.

Meanwhile, the inherent information of the mobile communication terminal as described above may be registered in the mobile communication system when a power of the mobile communication terminal is on, it occurs a hand off, and/or the mobile communication terminal is changed into a standby state GPS mode.

Herein, the ‘standby state GPS mode’ is a mode contrasted with Traffic mode, that is, a mode capable of chasing position of a mobile communication terminal without a change into Traffic mode.

In other words, if the mobile communication terminal 10 is changed into a standby state GPS mode, information required for chasing position can be transmitted/received under a state that the mobile communication terminal is not changed into Traffic mode. On the contrary, if the terminal is not changed into the standby state GPS mode, the information about chasing position of the mobile communication terminal is transmitted/received at Traffic mode as the prior art.

That is, the mobile communication terminal can be structured such that chasing position of the mobile communication terminal is performed through either the Traffic mode or the standby state GPS mode.

A method of chasing position of mobile communication terminal according to the present invention is as follows.

Inherent information of the mobile communication terminal is registered in the mobile communication system every preset time (S12).

Under the state, if request of chasing position of the mobile communication terminal from a user or another person is received (S13), the mobile communication system 11 transmits the GPS satellite information comprising AA 10 and simultaneously requests information required for chasing position (S14) to the mobile communication terminal.

The information required for the chasing position may comprise, for example, PRM such as Doppler, SV code phase and azimuth, a Reference PN, channel information, a SID, a NID, a Band Class, and PPM information such as pilot intensity.

The mobile communication terminal 10 receives the GPS satellite information and the request signal transmitted from the mobile communication system 11, via a paging channel during an idle state of a slot mode.

Generally, a mobile communication terminal does not always perform transmittance/reception with a mobile communication system under a state that a power thereof is on. Instead, a sleep state at which a signal is not received and an idle state at which a signal is received are repeated periodically. Like this, a mode at which the idle state and the sleep state are periodically repeated is referred to as a slot mode.

The reason of applying slot mode is to minimizing a battery power consumption of a mobile communication terminal. The mobile communication terminal checks whether paging message such as a calling signal and a short message signal, etc. are transmitted to the terminal every slot period.

In most of mobile communication terminals, the slot mode is applied to decrease the battery power consumption of a mobile communication terminal. If an index of a slot period is set up as ‘0’, ‘1’ and ‘2’ in the slot mode, a slot retrieving period driving a hardware in a mobile communication terminal so as to receive the paging message is determined as ‘1.28 seconds’, ‘2.56 seconds’ and ‘5.12 seconds’, respectively. The slot period could be set up by Mobile Network Operator (MNO).

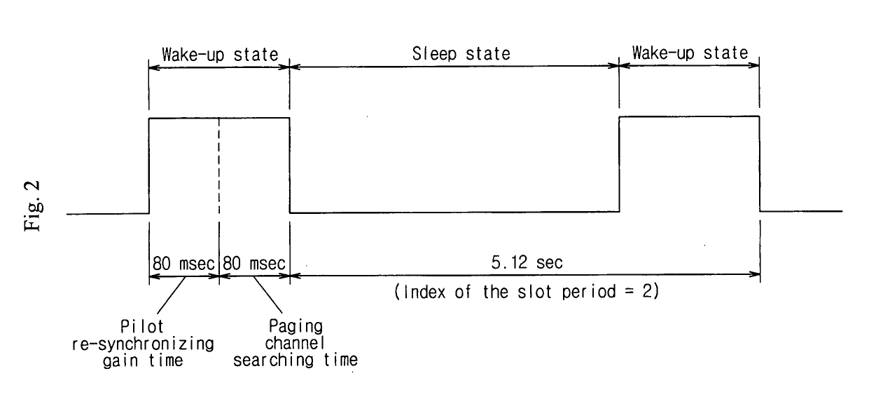

FIG. 2 shows a waveform of a slot of the mobile communication terminal 10, wherein a period of the slot mode is 5.12 seconds. As shown in FIG. 2, the slot mode is divided into an idle state and a sleep state, wherein the idle state is again divided into a pilot re-synchronizing gain time (80 ms) and a paging channel searching time (80 ms). In case that the slot period is set up like the above, the mobile communication terminal can receive the paging message and the GPS satellite information from the mobile communication system during the idle state of every slot period (5.12 seconds).

In the method of chasing position according to the invention, the GPS satellite information is received together with the paging message during the paging channel searching time in the slot mode. This distinguishes the invention from the prior art in which the mobile communication terminal receives the paging message only in slot mode.

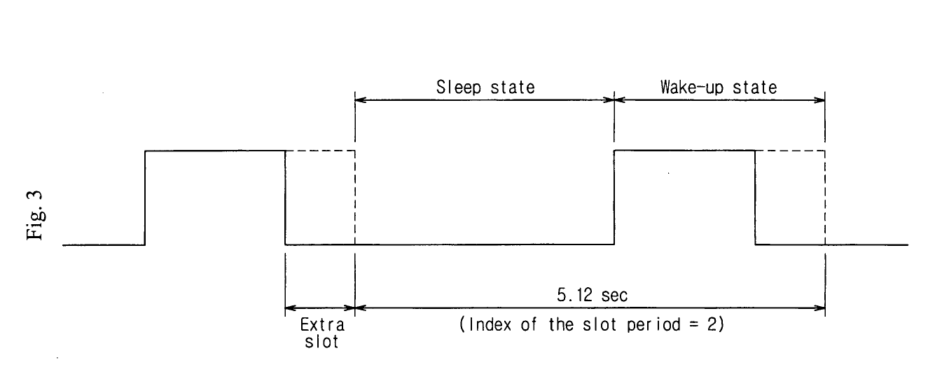

Meanwhile, in order to receive the GPS satellite information signal more stably, an extra slot can be added to the idle state shown in FIG. 2. That is, the idle sate of the mobile communication terminal is temporally extended in order to let the mobile communication terminal have sufficient time for receiving the GPS satellite information. As shown in FIG. 3, the idle state is temporally extended as the extra slot. In this case, since the slot period (5.12 seconds) is not changed, the time of sleep state is decreased as the extended idle state. In embodiment of FIG. 3, the extra slot is set up at 80 ms.

During the idle state, if the mobile communication terminal 10 receives the satellite information signal transmitted from the mobile communication system 11 via the paging channel, the mobile communication terminal is changed into a satellite-searching mode and thus searches a GPS satellite (S15).

The mobile communication terminal receives a GPS signal through a modem chip and transmits information for the received signal (PRM, PPM) to a position determination entity (PDE) of the mobile communication system via the access channel during the access time. (S16). The transmitting via the access channel is distinguished from the prior art that transmits via Traffic channel.

The access period is set up to transmit the information of the mobile communication terminal to the mobile communication system every predetermined time. For example, if the access period is set up to ‘10 minutes’, the mobile communication terminal 10 transmits the position information including the PRM and PPM to the mobile communication system 11 via the access channel every 10 minutes. Therefore, the mobile communication system can manage the information of the mobile communication terminal continuously.

Meanwhile, the PDE calculates a precise position of the mobile communication terminal, based on the PRM and PPM information received from the mobile communication terminal (S17). The position information calculated by the PDE is finally transmitted to a requester of the chasing position via a Mobile Network Operator (MNO) (S18).

As described above, according to the present invention, it is possible to transmit/receive the information required for chasing position between a mobile communication system and a mobile communication terminal without changing into Traffic mode.

Accordingly, it is possible to continuously receive the information even if there occurs a hand-off phenomenon during receiving the GPS satellite information, and there is no apprehension of an overload of a specific base station due to a capacity excess of Traffic channel. In addition, since it is not required to change into Traffic mode, a battery power is less consumed as much as that.

While the invention has been shown and described with reference to certain preferred embodiments thereof, it will be understood by those skilled in the art that various changes in form and details may be made therein without departing from the spirit and scope of the invention as defined by the appended claims.

1. A method of chasing position of a mobile communication terminal comprising:
registering inherent information of the mobile communication terminal with a mobile communication system;
transmitting a Global Positioning System (GPS) satellite information comprising Acquisition Assistance (AA) and requesting position information required for chasing position via a paging channel from the mobile communication system to the mobile communication terminal;
searching a GPS signal in the mobile communication terminal;
transmitting the position information obtained from the searching result via an access channel from the mobile communication terminal to the mobile communication system; and
calculating position of the mobile communication terminal, based on the position information transmitted via the access channel.

2. The method according to claim 1, wherein the inherent information comprises an Electronic Serial Number (ESN) and a Mobile Identification Number (MIN).

3. The method according to claim 1, wherein the paging channel is opened during an idle state in a slot mode of the mobile communication terminal.

4. The method according to claim 3, wherein the slot mode further comprises an extra slot.

5. The method according to claim 4, wherein the idle state of the slot mode is extended as much as the extra slot, and a sleep state of the slot mode is reduced as much as the extended idle state.

6. The method according to claim 1, wherein the transmittance of the position information via the access channel is performed every preset access period.

7. The method according to claim 1, wherein the information required for chasing position comprises Pseudo Range Measurement (PRM) and Pilot Phase Measurement (PPM) information.
